(19) United States
(12) Patent Application Publication
(10) Pub. No.: US 2014/0165826 A1
(43) Pub. Date: Jun. 19, 2014

(54) OIL SCRAPER RING

(71) Applicants: Dirk Baerenreuter, Odenthal (DE); Juergen Gillen, Leverkusen (DE); Christoph Mix, Emtebrueck (DE)

(72) Inventors: Dirk Baerenreuter, Odenthal (DE); Juergen Gillen, Leverkusen (DE); Christoph Mix, Emtebrueck (DE)

(73) Assignee: FEDERAL-MOGUL BURSCHEID GMBH, Burscheid (DE)

(21) Appl. No.: 14/232,999

(22) PCT Filed: May 30, 2012
(86) PCT No.: PCT/DE2012/000573

§ 371 Date: Jan. 15, 2014

(30) Foreign Application Priority Data
Jul. 21, 2011 (DE) 10 2011 108 280.1
Mar. 8, 2012 (DE) 10 2012 004 757.6

(51) Int. Cl. F16J 9/20

(52) U.S. Cl. CPC F16J 9/203
USPC 92/172

(57) ABSTRACT

An oil scraper ring, comprising a base body having a radially outer running surface, a radially inner circumferential surface, and an upper and a lower flank, the ring having at least two running surface lands, which are provided with a wear-resistant layer if needed and which, proceeding from the base body, are conically tapered at a predeterminable flank angle, radially in the direction of the ends thereof facing a counter running surface, forming limbs, and, proceeding from an oil chamber-side region, the free ends of the running surface lands being designed to be slanted at least in some regions in the direction of a combustion chamber-side region, wherein the respective transition regions from the slanted region of the running surface land into the limbs on the one hand, and from the limbs into the base body on the other hand, are rounded, the slanted region of the running surface land being operatively connected to a cylindrical section that extends in the direction of the oil chamber-side region, the radius of the scraping edge in the cylindrical section being 0.02 to 0.2 mm, the flank angle being ≦18°, and the width of the respective cylindrical section being <0.15 mm.

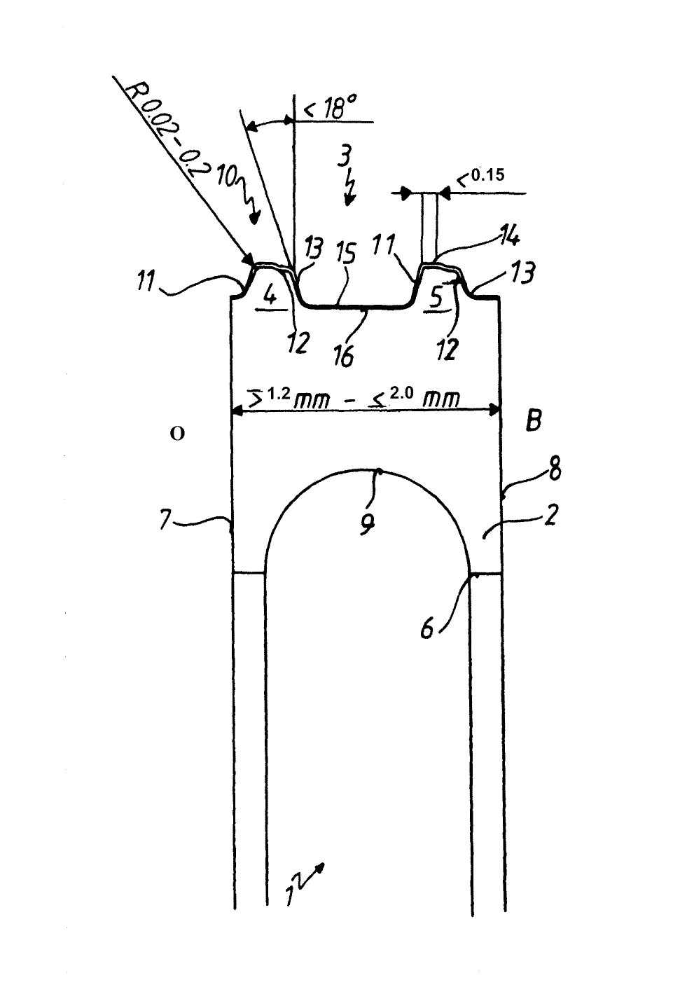

### BACKGROUND OF THE INVENTION

The invention relates to improvements to an oil scraper ring of the prior art, the prior art oil scraper ring being described in WO 2008/151589 A1 and comprising a base body having a radially outer running surface, a radially inner circumferential surface, and an upper and a lower flank, the ring having at least two running surface lands, which are provided with a wear-resistant layer if needed and which, proceeding from the base body, are conically tapered at a predeterminable angle, radially in the direction of the ends thereof facing a counter running surface and, proceeding from an oil chamber-side region, the free ends of the running surface lands being designed to be slanted at least in some regions in the direction of a combustion chamber-side region, wherein the respective transition regions from the slanted region of the running surface land into the limbs on the one hand, and from the limbs into the base body on the other hand, are rounded.

The oil scraper ring described here has conical running surface lands and a defined radius instead of a sharp scraping edge. While this scraping edge is gentle in terms of the wear of the counter running surface, such as a cylinder liner, it is not ideal with regard to the oil scraping action.

Moreover, an oil scraper piston ring became known from WO 01/53727 A1 which comprises at least one conical running land that is provided with a wear-resistant coating. A radial elevation, which is provided with a wear-resistant coating and has a predeterminable radial height and width, is provided in the region of the conical plane of the running land, whereby an inclined and a cylindrical section are created.

Due to the conical cylindrical running land, this oil scraper ring has very good oil scraping action. The disadvantage of this ring is that a sharp-edged scraping edge is created as a result of the production sequence described in this document (turning, coating, profile grinding of the preliminary contour and generating the finished contour). This sharp scraping edge in conjunction with the good oil scraping action results in increased wear of the counter running surface, for example of a cylinder liner, in some applications.

### SUMMARY OF THE INVENTION

It is the object of the invention to refine an oil scraper piston ring, which has similarly good oil scraping action as the oil scraper ring according to WO 01/53727 A1 which forms part of the prior art, but also reduces the wear of the counter running surface, for example of a cylinder liner.

This object is achieved by the slanted region of the running surface land being operatively connected to a cylindrical section that extends in the direction of the oil chamber-side region, the radius of the scraping edges present in the cylindrical section being 0.02 to 0.2 mm, the flank angle being ≦18°, and the width of the respective cylindrical section being <0.15 mm.

An oil scraper ring of the invention comprises a conical cylindrical running surface in the region of the running surface lands and a scraping edge having a radius of 0.02 to 0.2 mm, and more particularly of 0.02 to 0.05 mm. This ring therefore constitutes a compromise between the two oil scraper rings described at the beginning.

Moreover, flank angles of ≦15°, and more particularly between 5 and 15°, can be advantageous.

It can also be advantageous for the axial height of the base body to be ≧1.2 mm, and more particularly ≧1.5 mm.

Contrary to the oil scraper ring known from the prior art, the width of the cylindrical section of the running land can be reduced. This, in turn, is advantageous because the same surface pressure can be achieved with a lower tangential force than in the current oil scraper piston ring, whereby lower friction is achieved, which is associated with likewise lower CO₂ emission.

Since the contour of the newly proposed oil scraper ring is completely turned prior to coating, the flanks of the running lands may be steeper than in the current oil scraper ring where profile grinding is employed. Oil scraper rings having a very low axial height (≧1.2 mm) are therefore possible. However, the type of piston ring production can also be employed for oil scraper rings having today's customary axial heights. As a result of the low radius of the scraping edge, optimal protection of the counter running surface, and in particular of a cylinder liner, is ensured.

The oil consumption can be optimized due to the proposed flank angle.

The smaller width of the cylindrical running and portion has a friction-reducing effect.

The very low axial height likewise allows the height of the piston to be reduced, which is associated with a lower weight.

The subject matter of the invention is shown in the drawing based on an exemplary embodiment and is described as follows.

### BRIEF DESCRIPTION OF THE DRAWING

The drawing shows an oil scraper ring of the invention.

### DETAILED DESCRIPTION OF THE INVENTION

The single FIGURE shows an oil scraper ring 1 having a base body 2, which has a radially outer running surface 3. Running surface lands 4, 5 extend radially outward proceeding from the base body 2. The base body 2 further includes an inner circumferential surface 6 and a lower flank 7 and an upper flank 8. The lower flank 7 is associated with an oil chamber-side region O, and the flank 8 is associated with a combustion chamber-side region B. A peripheral groove 9 is introduced in the region of the inner circumferential surface 6 for receiving a spring washer, which is not shown. Proceeding from the base body 2, the running surface lands 4, 5 are tapered radially at a flank angle <18° in the direction of the ends 10 thereof facing a counter running surface, which is not shown, forming legs 11, 13, which are flanks of the running surface lands 4, 5, wherein, proceeding from the oil chamber-side region O, the free ends 10 of the running surface lands 4, 5 are provided with a slant 12 in the direction of the combustion chamber-side region B. A cylindrical section 14, which has a width of <0.15 mm, preferably from 0.03 to less than 0.15 mm adjoins the slanted region 12 in the direction of the oil chamber-side region O. Depending on the use of the oil scraper ring 1, the axial height of the piston ring may take on any desired dimension ≧1.2 mm. On the oil chamber side, the cylindrical section 14 transitions into the associated leg 11 at a radius between 0.02 and 0.2 mm, and preferably 0.02 to 0.05 mm.

The running surface lands 4, 5 are provided with at least one wear-resistant layer 15 in this example, which can be a diamond-like carbon (DLC) wear-resistant layer, for example formed by chemical vapor deposition (CVD) or physical vapor deposition for example. The layer thickness of the respective wear-resistant layer 15 can be up to a maximum of 20 μm and is provided not only on the outer circumferential surfaces of the running surface lands 4, 5, but also on the flanks 11, 13 of the running surface lands 4, 5 and the groove base 16 next to the running surface lands 4, 5.

1. (canceled)

2. The oil scraper ring according to claim 13, wherein the predetermined radius (R) of the scraping edge is 0.02 to 0.05 mm.

3. The oil scraper ring according to claim 13, wherein the predetermined angle is ≦15°.

4. The oil scraper ring according to any one of claims 13, wherein the predetermined angle is from 5 to 15°.

5. The oil scraper ring according to claim 13, wherein the axial width of the cylindrical section is from 0.03 to less than 0.15 mm.

6. The oil scraper ring according to claim 13, wherein the axial height of the base body is ≧1.2 mm.

7. The oil scraper ring according to claim 6, wherein the axial height of the base body is ≧1.5 mm.

8. The oil scraper ring according to claim 6, wherein the axial height of the base body is ≧1.2 mm to ≦2.0 mm.

9. The oil scraper ring according to claim 13, wherein the running surface is provided with the wear-resistant layer.

10. The oil scraper ring according to claim 13, wherein the wear-resistant layer comprises at least one chemical vapor deposition or physical vapor deposition wear-resistant layer.

11. The oil scraper ring according to claim 13, wherein the layer thickness of the wear-resistant layer is up to 20 μm.

12. The oil scraper ring according to claim 13, wherein, in addition to the running surface of the lands, the wear-resistant layer is also provided on the flanks of the lands and on a base of a groove between and formed by the lands.

13. An oil scraper ring, comprising a base body having a radially outer running surface, a radially inner circumferential surface, an upper flank facing toward an oil chamber and a lower flank facing toward a combustion chamber, the ring having at least two lands comprising the radially outer running surface, at least the running surface on the lands optionally being provided with a wear-resistant layer and the lands each having flanks inclined at a predetermined angle whereby each of the lands taper from the base body to the running surface on the land, the running surface on each of the lands having a cylindrical region beginning proximate an end of the land proximal the oil chamber, and a frustoconical region contiguous with the cylindrical region and tapering toward and ending proximate an end of the land proximal the combustion chamber, a curved scraping edge of predetermined radius being formed on each of the lands at a juncture of the running surface on the land with the flank of the land facing toward the oil chamber, the predetermined radius of each scraping edge being 0.02 to 0.2 mm, the predetermined angle at which the flanks of each of the lands are inclined being ≦18°, and an axial width of the cylindrical section of each of the lands being ≦0.15 mm.

14. The oil scraper ring according to claim 13, wherein the running surface of the lands is provided with the wear-resistant layer.
